(19) United States
(12) Patent Application Publication
(10) Pub. No.: US 2021/0109370 A1
(43) Pub. Date: Apr. 15, 2021

(54) INTERCHANGEABLE TINTED LENS GLASSES

(71) Applicant: Alexander Jackson, Glendale, CA (US)

(72) Inventor: Alexander Jackson, Glendale, CA (US)

(21) Appl. No.: 17/069,501

(22) Filed: Oct. 13, 2020

Related U.S. Application Data
(60) Provisional application No. 62/914,139, filed on Oct. 11, 2019.

(51) Int. Cl. G02C 1/06; G02C 1/00

(52) U.S. Cl. CPC G02C 1/06; G02C 5/14; G02C 2200/08; G02C 1/10

(57) ABSTRACT

An interchangeable eyeglass lens system allows for the placement and easy removal of lenses to a pair of glasses to create various shades and colors of sunglasses. The glasses may include a set of prescription lenses permanently fixed to the frame and a second set of lenses that slide into a groove in the frame. The present invention is further a method of interchanging the tinted lenses within the glasses.

### RELATED APPLICATION

The present application claims the benefit of U.S. Provisional Application No. 62/914,139 entitled “INTERCHANGEABLE TINTED LENS GLASSES”, filed Oct. 11, 2019, which is incorporated herein by reference in its entirety.

### TECHNICAL FIELD

The present invention relates generally to glasses, and, more particularly, to glasses with interchangeable tinted lenses that may be used to change the view from and of the glasses.

### BACKGROUND OF THE INVENTION

While many people wear glasses, the cost of prescription sunglasses, or even a second pair of sunglasses off the shelf, can be prohibitive. The market for clip-on lenses and the market for entirely removable and replaceable lenses are both limited. Clip-on lenses are fragile and break easily, they are hard to transport or fit in your pocket, they are not uniformly sized or fitted to glasses, they are offered only in one color per clip-on, they are easily losable and they are especially difficult and costly to replace, as they often need to be purchased in-person with the complementary spectacles present for confirmation of fit. Entirely replaceable lenses do not always possess clear, non-colored, or tinted lenses, and a person's prescriptions are not easily incorporated in the full set of replaceable lenses. In fact, to do so would be enormously expensive.

Any other prior art includes empty frames for placement of lenses that are connected to both eyes, disallowing singular lens changes, or includes a removable lens with a sliding locking system on top of the frames, introducing easily lost parts. Thus, there is a need for glasses with interchangeable lenses that are easy to remove and incorporate, are not easily broken or lost, and are inexpensive.

### SUMMARY OF THE INVENTION

An object of the present invention is to provide a wearer of glasses, sunglasses, protective glasses, or prescription glasses with the ability to protect the primary lenses of the glasses and to access a variety of, what shall be described herein as tints for their glasses. The present invention allows a user to make a variety of sunglass options that are cheaper and more accessible, customizable, portable, fashionable, image defining, and to create, revive, and modernize an antiquated personal function and fashion.

While the removable and replaceable element is described herein and throughout as a “tint” or “lens.” The primary or fixed lens of the glasses could be tinted and the replaceable “tint” could be untinted. It is not necessary for there to be a primary or fixed lens. The present invention can be accomplished with only replaceable tints or lenses in a frame.

In an embodiment, the tint may be placed within the glasses frame by sliding the tint down into a slot in front of the original lenses. To remove the tint, the user pushes a button release mechanism. In other embodiments, the tint may be twisted in from the side, or attached via magnets. In other embodiments the tint could be simply slid into a slot, and removing the tint could be accomplished by turning the glasses upside-down. In another embodiment, the frame itself could be undersized compared to the tint or lens so that the tint or lens can be removed by the user.

The inventions disclosed herein are applicable to frame designs that include but are not limited to the round frame, the cat eye, the semi rimless club master, the aviator, the oversized square, the classic black rim, the thin and lightweight metal frame, the slim, narrow oval & rectangular reading style, the stylish flat top glasses, the statement and bedazzled. Further, the inventions disclosed herein are applicable to lens designs including but not limited to non-corrective, corrective, tinted, non-tinted, bi-focal, and multifocal lenses.

In an embodiment of the present invention, a pair of glasses with a frame is configured to accept a tint and/or lens. Tints are slid into frame where the tints are received by a complementary receiver or slot within the frame.

In an embodiment, the primary lens is in front of receiver. A separator may be placed to keep primary lens and tints from touching each other. In another embodiment, there would be no separator, and primary lens and tints would be in contact.

The present invention is an eyeglass frame with a slot that allows for placement of replaceable lenses. The slot is disposed across the top of the frame and extends approximate the temple. In an embodiment, the invention is an eyeglass frame for interchangeable lenses, the eyeglass frame comprising; a pair of opposing side temple arms; and a lens holding frame that is connected to the opposing side temple arms, wherein the lens holding frame includes a nose piece, an interior lens frame and an exterior lens frame, said interior lens frame and exterior lens frame are spaced apart from each other. The lens holding frame defines a groove for an eyeglass lens to rest.

Further, the interior lens frame and the exterior lens frame may be connected to the nose piece, and the opposing side temple arms are connected to the interior lens frame by a hinge.

The eyeglass frame may further include where the exterior lens frame is comprised of a left exterior lens frame and a right exterior lens frame, said left exterior lens frame and right exterior lens frame are connected to the interior lens frame.

The interior lens frame and the exterior lens frame define a lens slot for placement of an eyeglass lens. The lens slot extends from the nose piece towards the side temple arm. The lens slot may extend from the nose piece along an upper face of the interior lens frame and further extends along an outer face of the interior lens frame.

The present invention is an interchangeable eyeglass lens system for inserting and removing an eyeglass lens from an eyeglass frame, the interchangeable eyeglass lens system comprising; the eyeglass frame and the eye glass lens, wherein the eyeglass frame includes; a pair of opposing side temple arms; and a lens holding frame that is connected to the opposing side temple arms, wherein the lens holding frame includes a nose piece, an interior lens frame and an exterior lens frame, said interior lens frame and exterior lens frame include a lens slot, and wherein the eyeglass lens including at least one appendage that extends beyond the lens holding frame, said eyeglass lens sized to fit within the lens slot.

The interchangeable eyeglass lens system includes wherein the opposing side temple arms are connected to the interior lens frame by a hinge.

The interchangeable eyeglass lens system includes wherein the exterior lens frame is comprised of a left exterior lens frame and a right exterior lens frame, said left exterior lens frame and right exterior lens frame are connected to the interior lens frame.

The interchangeable eyeglass lens system includes wherein the lens holder frame defines a groove for the eyeglass lens to rest. Further, wherein the lens slot extends from the nose piece towards the side temple arm.

The interchangeable eyeglass lens system includes wherein the lens slot extends from the nose piece along an upper face of the interior lens frame and further extends along an outer face of the interior lens frame.

The interchangeable eyeglass lens system includes wherein the eyeglass lens and the appendage are constructed of the same material. The eyeglass appendage may be disposed on the eyeglass lens closest to the side temple arm. The eyeglass lens may further include a second appendage that extends beyond an opening in the lens frame.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 depicts a perspective view of an embodiment of glasses frames that allow for removable tints.

FIG. 2 depicts the eyeglasses of FIG. 1 from the top.

FIG. 3 depicts the eyeglasses of FIG. 1 from the front.

FIG. 4 depicts the tints to be used with the eyeglasses of FIG. 1.

FIG. 5 depicts the tints of FIG. 4 inserted into the eyeglasses of FIG. 1.

FIG. 6 depicts a front perspective view of another embodiment of eyeglasses frames that allow for removable tints.

FIG. 7 depicts a rear perspective view of the eyeglass frames from FIG. 6

FIG. 8 depicts a top planar view of the eyeglass frames from FIG. 6.

FIG. 9 depicts a perspective view of the frame of the eyeglass from FIG. 6 with tinted lenses.

FIG. 10 depicts front planar view of the frame of the glasses from the glasses of FIG. 9 with lenses partially removed

FIG. 11 is a closeup view of a portion of the frame of FIG. 9

FIG. 12 is an embodiment of the tinted lens from FIG. 9

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

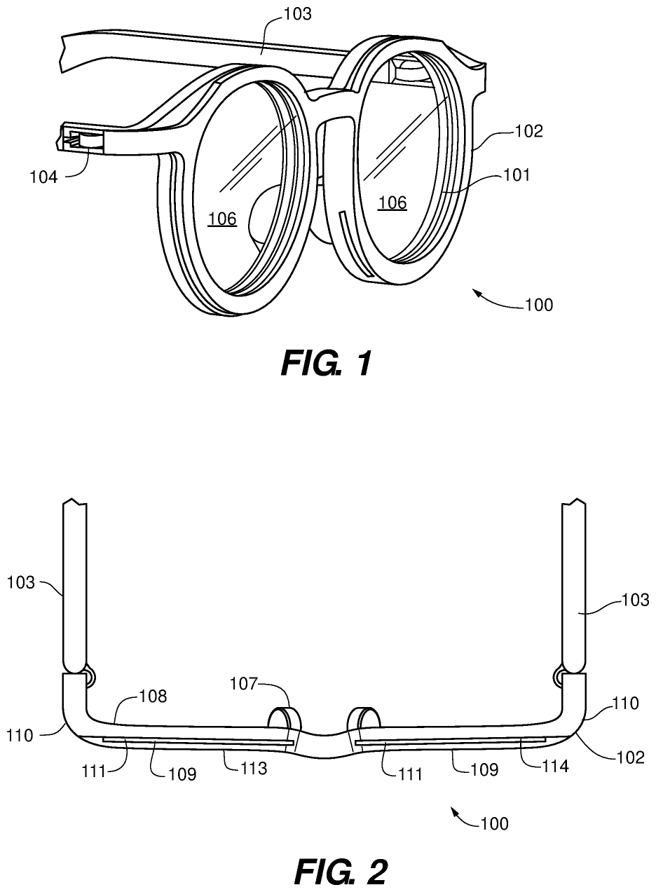

FIGS. 1-5 depicts an embodiment of the present invention 100. The interchangeable eyeglass lens system 100 includes a front frame 102, temple sidearms 103, and a pair of hinges 104 that connect the temple sidearms 103 to front frame 102. The interchangeable eyeglass lens system 100 further includes replaceable lenses 105. A pair of prescription lenses 106 may be installed in the front frame 102.

FIG. 1 is a perspective view of the interchangeable eyeglass lens system 100 with a pair of prescription lenses 106 in place.

FIG. 2 is top planar view of the interchangeable eyeglass lens system 100. Front frame 102 further comprises a nose piece 107 disposed centrally in the front frame 102. An interior eyeglass frame 108 is disposed closest to the users face and would in an embodiment include a prescription lens 106. An outer eyeglass frame 109 further extends from temple 110 to opposing temple 110. The outer eyeglass frame 109 defines a slot 111 for inserting the interchangeable lenses 112. Slot 111 extends from approximate the noise piece 107 to the temple 110 on the top frame face 113 and is discontinuous along the bottom frame face 114.

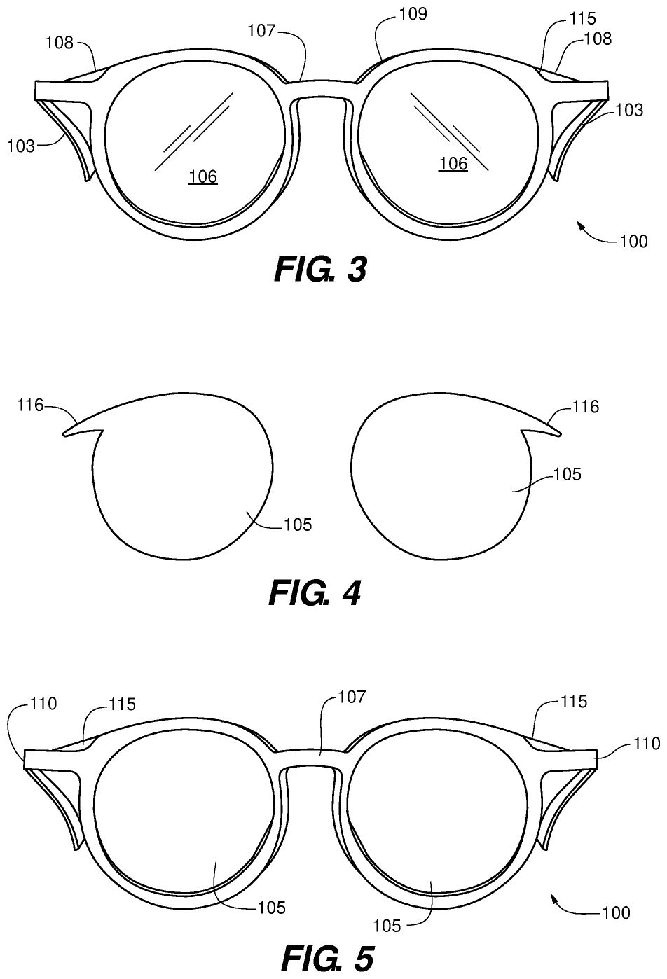

FIG. 3 depicts a front planar view of the interchangeable eyeglass lens system 100 with the prescription lenses 106 in place. The outer eyeglass frame 109 does not completely follow the size of the interior eyeglass frame 108. A lens access area 115 is formed near the temple 110 so that a portion of replaceable lens 105 can be accessed by a user.

FIG. 4 depicts a front planar view of replaceable lens 105. Here replaceable lens 105 is darker shade than the prescription lenses. Replaceable lens 105 can any have any variety of colors or tints. Furthermore, the replaceable lens 105 may be of different tints so that a left lens is darker than a right lens. Replaceable lens 105 includes a lens appendage 116 that rests within lens access area 115. In this embodiment the lens access area 115 is forward facing. It is envisioned that lens access area 105 could be rear facing by having the interior eyeglass frame 108 sized smaller that outer eyeglass frame 109.

FIG. 5 depicts a front planar view of the interchangeable eyeglass lens system 100 with replaceable lens 105 installed.

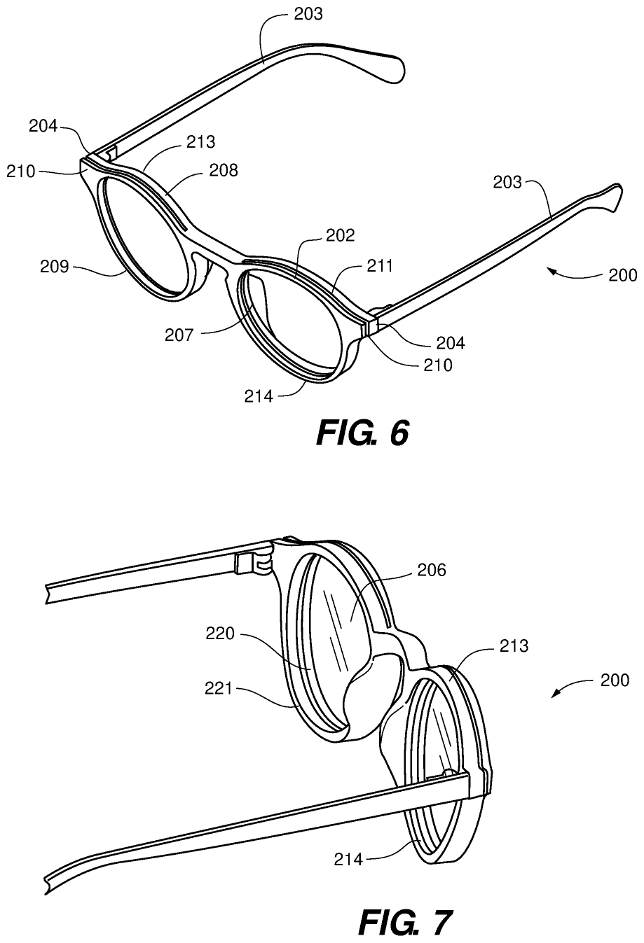

FIGS. 6-12 depicts an alternate embodiment of the present invention 200. FIGS. 6-8 depict the interchangeable eyeglass lens system 200 for tinted lenses. Interchangeable eyeglass lens system 200 includes a front frame 202, temple sidearms 203, and a pair of hinges 204 that connect the temple sidearms 203 to front frame 102. The interchangeable eyeglass lens system 200 further includes replaceable lenses 205. A pair of prescription lenses 206 may be installed in the front frame 202, typically closer to the user's eye.

FIG. 6 is a perspective view of the interchangeable eyeglass lens system 200. Front frame 202 includes interior eyeglass frame 208 and outer eyeglass frame 209. Interior eyeglass frame 208 and outer eyeglass frame 209 define a slot 211 along top frame face 213. Interior eyeglass frame 208 and outer eyeglass frame 209 are connected along bottom frame face 214. Bottom frame face 214 includes a prescription lens groove 221 and tinted/interchageable lens grove 220.

FIG. 7 is a perspective view of the interchangeable eyeglass lens system 200 from the rear with a pair of prescription lenses 206 in place. The tinted lens groove 220 and the prescription lens groove 221 are located at the lower interior face of the front frame 202.

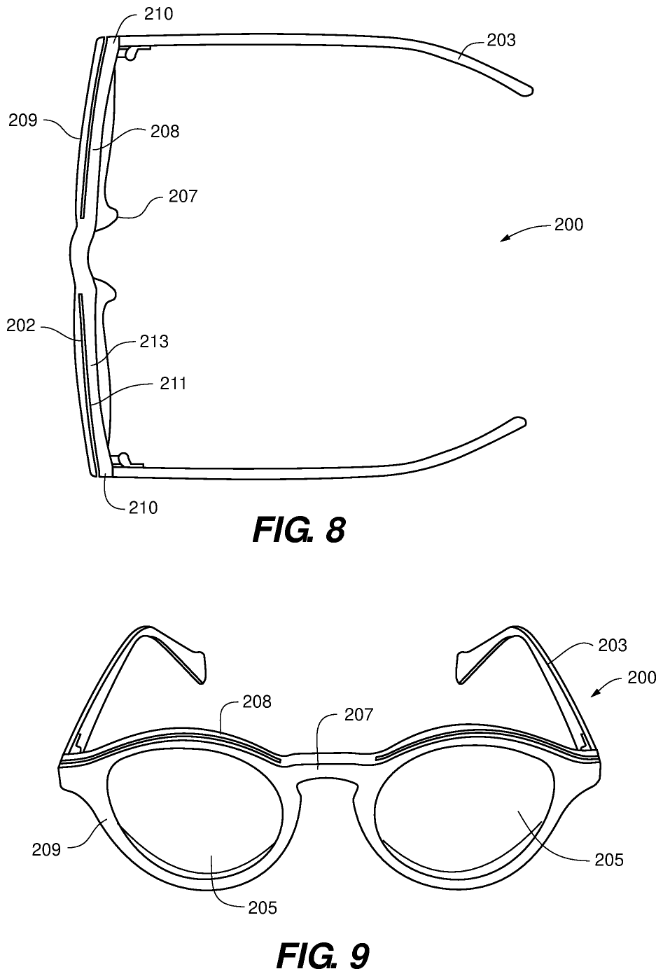

FIG. 8 is top planar view of the interchangeable eyeglass lens system 200. Front frame 202 further comprises a nose piece 207 disposed centrally in the front frame 202. An interior eyeglass frame 208 is disposed closest to the users face and would in an embodiment include a prescription lens 206. An outer eyeglass frame 209 further extends from temple 210 to opposing temple 210. The outer eyeglass frame 209 defines a slot 211 for inserting the interchangeable lenses 212. Slot 211 extends from approximate the noise piece 207 to the temple 210 on the top frame face 213. Tinted lens groove 220 is continuous along the bottom frame face 214.

FIG. 9 depicts a front perspective view of the interchangeable eyeglass lens system 200 with the tinted lenses 205 in place. The outer eyeglass frame 209 mirrors the size of the interior eyeglass frame 208.

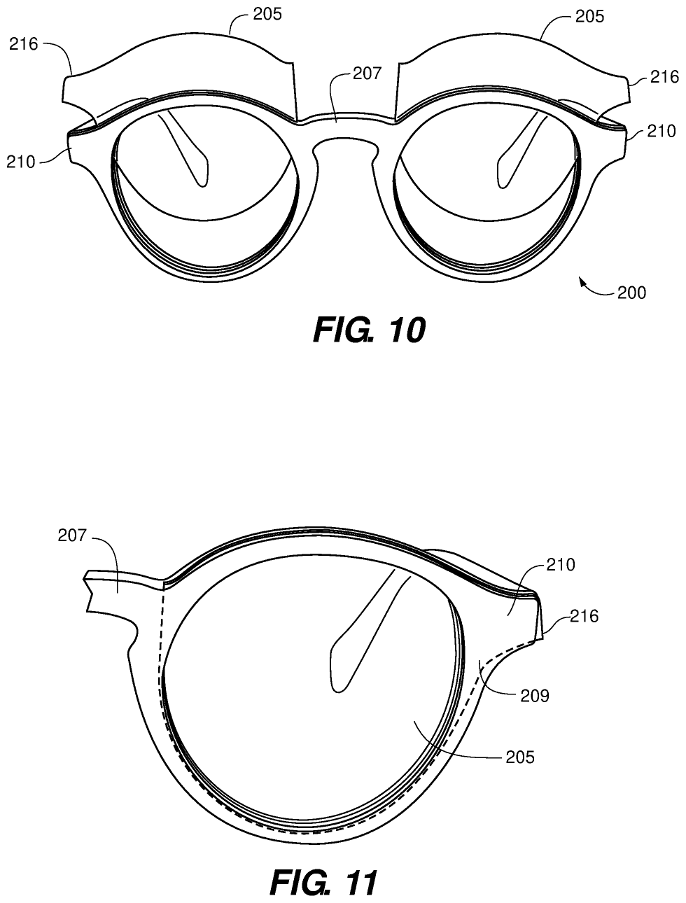

FIG. 10 depicts a front planar view of the replaceable lens 205 partially installed in the interchangeable eyeglass lens system 200. Here, replaceable lens 205 is a darker shade than the prescription lenses. Replaceable lens 205 can any have any variety of colors or tints. Furthermore, the replaceable lens 205 may be of different tints so that a left lens is darker than a right lens. As depicted in FIG. 11, replaceable lens 205 includes a lens appendage 216 that extends beyond the outer edge of the front frame near the temple.

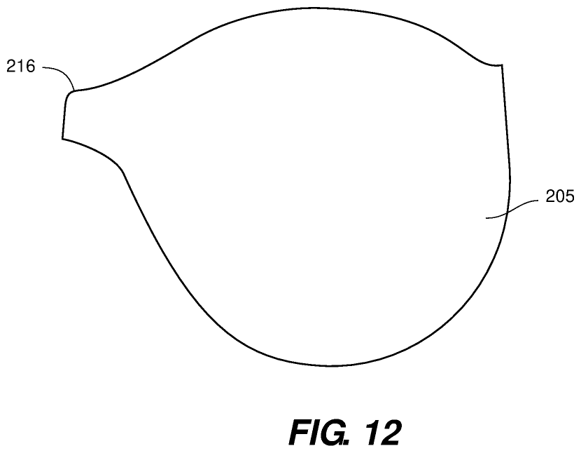

FIG. 12 depicts a planar view of the replaceable tinted lens. The position and shape of the appendage 216 can be varied. For example, appendage 216 could have a more rounded structure, include a nub, or a groove for easier access. The location could be shifted to along the top of the frame or lower on the side of the frame.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

1. An eyeglass frame for an interchangeable lens, the eyeglass frame comprising;
a pair of opposing side temple arms; and
a lens holding frame that is connected to the opposing side temple arms, wherein the lens holding frame includes a nose piece, an interior lens frame and an exterior lens frame, said interior lens frame and exterior lens frame are parallel and spaced apart from each other so as to define a lens slot for the interchangeable lens.

2. The eyeglass frame of claim 1 wherein the interior lens frame and the exterior lens frame are connected to the nose piece.

3. The eyeglass frame of claim 1 wherein the opposing side temple arms are connected to the interior lens frame by a hinge.

4. The eyeglass frame of claim 1 wherein the exterior lens frame is comprised of a left exterior lens frame and a right exterior lens frame, said left exterior lens frame and right exterior lens frame are connected to the interior lens frame.

5. The eyeglass frame of claim 1 wherein the interior lens frame defines a groove for a fixed eyeglass lens to rest.

6. The eyeglass frame of claim 1 wherein the interior lens frame and the exterior lens frame define a separate lens slot for placement of a left and a right interchangeable eyeglass lens.

7. The eyeglass frame of claim 6 wherein the lens slot extends from the nose piece towards the side temple arm.

8. The eyeglass frame of claim 7 wherein the lens slot extends from the nose piece along an upper face of the interior lens frame and further extends along an outer face of the interior lens frame.

9. An interchangeable eyeglass lens system for inserting and removing an eyeglass lens from an eyeglass frame, the interchangeable eyeglass lens system comprising;
the eyeglass frame and
the eye glass lens,
wherein the eyeglass frame includes;
a pair of opposing side temple arms; and
a lens holding frame that is connected to the opposing side temple arms,
wherein the lens holding frame includes a nose piece, an interior lens frame and an exterior lens frame, said interior lens frame and exterior lens frame define a lens slot for insertion of the interchangeable eyeglass lens, and
wherein the interchangeable eyeglass lens including at least one appendage that extends beyond the lens holding frame, said interchangeable eyeglass lens sized to fit within the lens slot.

10. The interchangeable eyeglass lens system of claim 9 wherein the opposing side temple arms are connected to the interior lens frame by a hinge.

11. The interchangeable eyeglass lens system of claim 9 wherein the exterior lens frame is comprised of a left exterior lens frame and a right exterior lens frame, said left exterior lens frame and right exterior lens frame are connected to the interior lens frame at the nose piece.

12. The interchangeable eyeglass lens system of claim 9 wherein the lens holder frame defines a groove for the interchangeable eyeglass lens to rest.

13. The interchangeable eyeglass lens system of claim 9 wherein the lens slot extends from the nose piece towards the side temple arm.

14. The interchangeable eyeglass lens system of claim 13 wherein the lens slot extends from the nose piece along an upper face of the interior lens frame and further extends along an outer face of the interior lens frame.

15. The interchangeable eyeglass lens system of claim 9 wherein the interchangeable eyeglass lens and the appendage are constructed of the same material.

16. The interchangeable eyeglass lens system of claim 9 wherein the eyeglass appendage is disposed on the interchangeable eyeglass lens closest to the side temple arm.

17. The interchangeable eyeglass lens system of claim 9 wherein the interchangeable eyeglass lens further includes a second appendage that extends beyond an opening in the lens frame.

18. A method for adding and removing a tinted lens to an eyeglass frame, the method comprising,
a. Inserting a tinted lens into a slot in the eyeglass frame, the slot positioned adjacent and parallel to a prescription lens'
b. Holding the tinted lens within the slot by a groove that extends from a nose piece across the bottom side of the frame, said slot closely sized to the thickness of the lens, and
c. Removing the lens from the slot by accessing a lens appendage which extends beyond the perimeter of the frame.
